(19) United States
(12) Patent Application Publication
(10) Pub. No.: US 2010/0289713 A1
(43) Pub. Date: Nov. 18, 2010

(54) SLOT ANTENNA

(76) Inventor: TORU TAURA, Tokyo (JP)

Correspondence Address: Mr. Jackson Chen, 6535 N. STATE HWY 161, IRVING, TX, 75039, US

(21) Appl. No.: 12/600,220

(22) PCT Filed: Apr. 23, 2008
(86) PCT No.: PCT/JP2008/057818

§ 371 Date: Nov. 13, 2009

(30) Foreign Application Priority Data
May 16, 2007 (JP) 2007-130857

(51) Int. Cl. H01Q 13/10

(52) U.S. Cl. 343/767

(57) ABSTRACT

To realize an antenna made thinner. A slot antenna includes: an antenna element having an aperture slit shaped slot; a reflector disposed by being opposed to the antenna element; a feeding device which is electrically and physically connected to the antenna element and the reflector; a short-circuiting device which electrically short-circuits the antenna element and the reflector; and a frequency switching device, which is provided on the slot, for switching resonance frequencies of the slot. The impedance generated by the approach between the antenna element and the reflector can be improved to prevent mismatching and the distance therebetween can be reduced to make an antenna thinner.

### TECHNICAL FIELD

The present invention relates to a slot antenna having a reflector. More specifically, the present invention relates to a thin-type slot antenna which enables operations with a plurality of frequency bands.

### BACKGROUND ART

Recently, portable wireless terminals have been required to be thin and to have a connecting function to various wireless networks. Accordingly, there has been an increasing demand for the antenna loaded on the portable wiring terminal to be thin because of limited mounting space and demand for corresponding to multibands required for being connected to various kinds of wireless services.

As the portable wireless terminals become thinner, the antennas loaded on the portable wireless terminals become susceptible to the external factors such as hands or human bodies because the distance between the antenna and the external factors becomes close when the portable wireless terminals are in use. This results in causing deterioration in the communication performance of the portable wireless terminals, particularly the deterioration of the antenna characteristic during communications, due to deterioration in the antenna characteristic.

As a structure for lightening the influence caused by the external factors, there is known a structure in which a metal plate (reflector) is interposed between the antenna and the external loss factor. In the antenna structure having the reflector, an operation band generally becomes narrower when the distance between the reflector and the antenna becomes closer. Thus, as a technique for widening the band of the antenna structure having the reflector, there is disclosed a structure in which a plurality of antenna elements are stacked (Patent Documents 1 and 2).

As shown in FIGS. 16A and 16B, the structure disclosed in Patent Document 1 has a parasitic element 31 loaded on a microstrip antenna that has an emission element 30 provided on a dielectric substrate, and it is a band widening technique which utilizes double resonance by the microstrip antenna and the parasitic element.

As shown in FIG. 17, the structure disclosed in Patent Document 2 is a technique which widens the band by achieving a 2-frequency common characteristic through stacking two different microstrip antennas 40, 41 with different resonance frequencies vertically, and feeding power to each of the microstrip antennas 40, 41 from a cable 42, respectively.

### Patent Document 1: Japanese Unexamined Patent Publication 2001-326528

### Patent Document 2: Japanese Unexamined Patent Publication 2003-249818

### DISCLOSURE OF THE INVENTION

### Problems to be Solved by the Invention

However, the antenna structures disclosed in Patent Document 1 and Patent Document 2 are the structures in which the antenna elements are stacked vertically for achieving the double-resonance characteristic, so that the thickness of the antenna becomes thick in the vertical direction.

An object of the present invention relates to the slot antenna having a reflector, and it is to provide the slot antenna which can be formed thin white considering the above issue.

### Means for Solving the Problem

In order to achieve the foregoing object, the slot antenna according to the present invention includes: an antenna element having an aperture slit shaped slot; a reflector disposed by being opposed to the antenna element; a feeding device which is electrically and physically connected to the antenna element and the reflector; a short-circuiting device which electrically short-circuits the antenna element and the reflector; and a frequency switching device, which is provided on the slot, for switching resonance frequencies of the slot.

### EFFECT OF THE INVENTION

The present invention can prevent mismatching through improving the impedance generated because the antenna element comes closer to the reflector, so that the antenna can be formed thin by shortening the distance between the antenna element and the reflector.

### BEST MODES FOR CARRYING OUT THE INVENTION

An exemplary embodiment of the invention will be described hereinafter by referring to the drawings.

As shown in FIG. 1-FIG. 15, a slot antenna according to the exemplary embodiment of the invention includes, as a basic structure: an antenna element 2 having an aperture slit shaped slot 1; a reflector 3 disposed by opposing to the antenna element 2; a feeding device 4 which is electrically and physically connected to the antenna element 2 and the reflector 3; and a short-circuiting device 5 which electrically short-circuits the antenna element 2 and the reflector 3. To electrically and physically connect means that the feeding device 4 is mechanically connected to the antenna element 2 and the reflector 3 and, while keeping that coupled state, the feeding device 4 is electrically connected to be conductive to the antenna element 2 and the reflector 3.

In a case of a transmitting antenna, the feeding device 4 functions as a power feeding terminal which feeds power to the antenna element 2 and the reflector 3 for sending transmission signals. In a case of a receiving antenna, the feeding device 4 functions as a power receiving terminal which takes in electric currents that are induced on the antenna by the incoming electromagnetic waves.

With the related slot antenna having the reflector, the impedance of the antenna is deteriorated when the distance between the antenna element and the reflector is shortened for thinning the antenna. This causes mismatching with a wireless circuit, so that it becomes difficult to perform transmission/reception with high efficiency.

In the exemplary embodiment of the invention, the antenna element 2 and the reflector 3 are electrically short-circuited by the short-circuiting device 5. Thus, the impedance of the antenna can be increased by the short-circuiting device 5. As a result, transmission/reception can be performed with high efficiency by overcoming the mismatching with the wireless circuit to which the feeding device 4 is connected.

In addition to the above structure, the exemplary embodiment of the invention may also be built by adding a frequency switching device 6 for switching the resonance frequency of the slot 1.

The structure to which the frequency switching device 6 is added is capable of corresponding to multibands through switching the resonance frequency of the slot 1 by using the frequency switching device 6.

Next, cases to which the exemplary embodiment of the invention is applied will be described as EXAMPLES.

### Example 1

As shown in FIG. 1A, FIG. 1B, and FIG. 1C, EXAMPLE 1 of the present invention includes an antenna element 2 having an aperture slit shaped slot 1, a reflector 3, a feeding device 4, and a short-circuiting device 5.

As shown in FIG. 1A and FIG. 1B, the antenna element 2 is obtained by forming the slot 1 to a metal-made flat type emission plate 2a. The slot 1 is an aperture slit shape having an electric length which corresponds to a quarter wavelength of the frequency to be used. An opening end 1a of the slot 1 is opened at an end 2b of the emission plate 2a, and a short-circuit end 1b of the slot 1 is disposed on the inner side than the end 2b of the emission plate 2. While the slot 1 of EXAMPLE 1 is formed in an L-letter shape, the present invention is not limited only to such case. That is, the slot 1 may be in any shapes as long as it is in the shape in which electric fields are concentrated at the opening end 1a of the slot 1.

As shown in FIG. 1A and FIG. 1B, the reflector 3 is disposed by being opposed to the antenna element 2, and has a function of reflecting, electromagnetic waves. The external size of the reflector 3 is formed to be larger than the external size of the antenna element 2. The reflector 3 may be of a metal-made flat type or may be of a structure in which a reflection layer is formed on the surface of a resin plate, and the reflection layer is disposed by opposing to the antenna element 2. The point is that the reflection structure of the reflector 3 may be of any types, as long as it is possible to reflect radio waves from the antenna element 2 towards the antenna element 2 efficiently.

As shown in FIG. 1A and FIG. 1C, the feeding device 4 is connected to the antenna element 2 and the reflector 3 electrically and physically. While the feeding device 4 is shown with a solid line in FIG. 1A for making it clear, the feeding device 4 is disposed between the antenna element 2 and the reflector 3 and connected to the antenna element 2 and the reflector 3 electrically and physically as shown in FIG. 1C. As the feeding device 4, it is possible to use a coaxial cable that is configured with a center conductor and an outer sheath conductor. The center conductor of the coaxial cable is connected to the antenna element 2 electrically and physically, and the outer sheath conductor of the coaxial cable is connected to the reflector 3 electrically and physically. To electrically and physically connect means that the feeding device 4 is mechanically connected to the antenna element 2 and the reflector 3 and, while keeping that coupled state, the feeding device 4 is electrically connected to be conductive to the antenna element 2 and the reflector 3.

As shown in FIG. 1A and FIG. 1C, the short-circuiting device 5 is used for electrically short-circuiting the antenna element 2 and the reflector 3. While the short-circuiting device 5 is shown with a solid line in FIG. 1A for making it clear, the short-circuiting device 5 is disposed between the antenna element 2 and the reflector 3 to electrically short-circuit the antenna element 2 and the reflector 3 as shown in FIG. 1C. As shown in FIG. 1A and FIG. 1C, it is desirable for the short-circuiting device 5 to be disposed in the vicinity of the feeding device 4 and to electrically short-circuit at least one point between the antenna element 2 and the reflector 3. The number of points to be short-circuited by using the short-circuiting device 5 is determined in accordance with a degree of increase in the impedance of the antenna that is increased according to the shortened distance between the antenna element 2 and the reflector 3.

While the above structure is necessary for thinning the antenna, it is also possible to provide the frequency switching device 6 for corresponding to multibands.

The frequency switching device 6 is used for switching the resonance frequency of the slot 1.

In general, the slot antenna is formed by making a thin and long cut into a metal plate. In addition to the thin and long cut shape as the shapes of the slot, there is also a notch shape whose one end is an open end. EXAMPLE 1 of the present invention is directed to the slot antenna having the latter shape, i.e., the notch shape. An electric field and a magnetic field are generated in the slot 1 through feeding the power by the feeding device 4 to the area A with a narrow width in the slot 1 according to EXAMPLE 1 off the present invention. When the slot length becomes one fourth of the used frequency wavelength, there is generated the resonance with which the electric field becomes the maximum at the opening end 1a of the slot 1 and becomes the minimum at the short-circuit end 1b. This enables the slot antenna to function as the antenna.

Next, described is a case where the slot antenna according to EXAMPLE 1 functions as a transmitting antenna.

When the power of the frequency having the electric length of the slot 1 as a quarter wavelength is fed to the antenna element 2 and the reflector 3 from the feeding device 4, resonance is induced in the slot 1. Thereby, electromagnetic waves are emitted by the electric fields distributed on the slot 1 and the electric currents spread on the antenna element 2 and the reflector 3 from the slot 1. At this time, the emission direction of the electromagnetic waves exhibits a directivity by the effect of the reflector 3, and stronger emission is generated on the side where the slot 1 is disposed.

Next, described is a case where the slot antenna according to EXAMPLE 1 functions as a receiving antenna.

When the electromagnetic waves of the frequency having the electric length of the slot 1 as a quarter wavelength come in, electric currents are induced in the antenna element 2, and an electric field and a magnetic field are induced on the slot 1, respectively, which are received via the feeding device 4. At this time, due to an effect of the reflector 3, the slot antenna exhibits a still higher sensitivity for the electromagnetic waves coming in from the side where the slot 1 is disposed.

With the related slot antenna having the reflector, the impedance of the antenna is deteriorated when the distance between the antenna element and the reflector is shortened for thinning the antenna. This causes mismatching with a wireless circuit, so that it becomes difficult to perform transmission/reception with high efficiency.

In EXAMPLE 1 of the present invention, the antenna element 2 and the reflector 3 are electrically short-circuited by the short-circuiting device 5. Thus, the impedance of the antenna can be increased by the short-circuiting device 5. As a result, transmission/reception can be performed with high efficiency by overcoming the mismatching with the wireless circuit to which the feeding device 4 is connected.

EXAMPLE 1 of the present invention is built as the structure to which the frequency switching device 6 for switching the resonance frequency of the slot 1 is added. Thereby, it becomes possible to correspond to multibands through switching the resonance frequency of the slot 1 by using the frequency switching device 6.

### Example 2

EXAMPLE 2 shown in FIG. 2 is a modification of EXAMPLE 1 shown in FIG. 1, in which an adjuster 7 for reducing the reactance component of the antenna is employed.

As shown in FIG. 2A, FIG. 2B, and FIG. 2C, the adjuster 7 of EXAMPLE 2 is structured to reduce the reactance component for the slot 1 by having the end 2b where the opening end 1a of the slot 1 in the antenna element 2 is formed projected towards the outer side with respect to the end 3a of the reflector 3. Other structures are the same as those of EXAMPLE 1.

In EXAMPLE 2, the end 2b of the antenna element 2 is disposed by being shifted towards the outer side with respect to the reflector 3. Therefore, the reactance component of the antenna can be decreased and the antenna band can be expanded. Particularly, the effects thereof become conspicuous by shifting the end 2b of the antenna element 2 where the opening end 1a of the slot 1 in which the strong electric field components are concentrated is provided towards the outer side with respect to the reflector 3.

Further, through shifting the end 2b of the antenna element 2 where the opening end 1a of the slot 1 is provided, it is possible with EXAMPLE 2 to keep the end 2b of the antenna element 2 away from the end 3a of the reflector 3. This makes it possible to suppress induction of the induced electric currents which hinder emission and reception, without increasing the thickness of the antenna. Thereby, it becomes possible to achieve an antenna which can be formed thin and can emit and receive electromagnetic waves efficiently.

In FIG. 2, the end 2b of the antenna element 2 is shifted towards the outer side with respect to the reflector 3. However, the present invention is not limited only to such case. For example, it is possible to employ a structure in which a part of the reflector 3 opposing to the slot 1 is eliminated. Particularly, the effects thereof become conspicuous when the reflector right beneath the opening end 1a of the slot 1 where the electric field components are concentrated is eliminated. The point is that any structures can be employed, as long as it is possible to reduce the reactance component of the antenna.

### Example 3

The slot is structured as a single-resonance type slot in EXAMPLE 1 shown in FIG. 1, whereas the slot is structured as a double-resonance type slot in EXAMPLE 3 shown in FIG. 3.

As shown in FIG. 3A, FIG. 3B, and FIG. 3C, in EXAMPLE 3, a slot 1′ of the same structure as that of the slot 1 is added, and the frequency switching devices 6, 6 are provided to the slots 1, 1′, respectively. The slot 1 and the slot 1′ configuring the double-resonance type slots are formed in different lengths. Further, the feeding device 4 and the short-circuiting device 5 are provided in common for the double-resonance type slots 1, 1′. Other structures including the opening end 1a′ and the short-circuit end 1b′ of the slot 1 are the same as those of EXAMPLE 1.

The two slots 1 and 1′ in different lengths are provided to the antenna element 2 in EXAMPLE 3, so that it is possible to have resonance at frequencies depending on each of the slot lengths. Therefore, it is possible to achieve a wider band than the case of EXAMPLE 1.

### Example 4

EXAMPLE 4 shown in FIG. 4 is a modification of EXAMPLE 3 shown in FIG. 3, in which an adjuster 7 for reducing the reactance component of the antenna is employed.

As shown in FIG. 4A, FIG. 4B, and FIG. 4C, the adjuster 7 of EXAMPLE 4 is structured to reduce the reactance component for the antenna by having the end 2b where the opening ends 1a, 1a′ of the slots 1, 1′ in the antenna element 2 is formed by being projected towards the outer side with respect to the end 3a of the reflector 3. Other structures are the same as those of EXAMPLE 3.

In EXAMPLE 4, the end 2b of the antenna element 2 is disposed by being shifted towards the outer side with respect to the reflector 3. Therefore, the reactance component of the antenna can be decreased and the antenna band can be expanded. Particularly, the effects thereof become conspicuous by shifting the end 2b of the antenna element 2 where the opening ends 1a, 1a′ of the slots 1, 1′ in which the strong electric field components are concentrated is provided with respect to the reflector 3.

Further, through shifting the end 2b of the antenna element 2 where the opening ends 1a, 1a′ of the slots 1, 1′ is provided, it is possible with EXAMPLE 4 to keep the end 2b of the antenna element 2 away from the end 3a of the reflector 3. This makes it possible to suppress induction of the induced electric currents which hinder emission and reception, without increasing the thickness of the antenna. Thereby, it becomes possible to achieve an antenna which can be formed thin and can emit and receive electromagnetic waves efficiently.

In FIG. 2, the end 2b of the antenna element 2 is shifted towards the outer side with respect to the reflector 3. However, the present invention is not limited only to such case. For example, it is possible to employ a structure in which a part of the reflector 3 opposing to the slots 1, 1′ is eliminated. Particularly, the effects thereof become conspicuous when the reflector right beneath the opening ends 1a, 1a′ of the slots 1, 1′ where the electric field components are concentrated is eliminated. The point is that any structures can be employed, as long as it is possible to reduce the reactance component for the slots 1, 1′ can be reduced.

### Example 5

EXAMPLE 5 shown in FIG. 5 is a modification of EXAMPLE 1 shown in FIG. 1. While one frequency switching device 6 is provided to the slot 1 of the antenna element 2 in EXAMPLE 1, two frequency switching devices 6 are provided to the slot 1 of the antenna element 2 in EXAMPLE 5 as shown in FIG. 5A, FIG. 5B, and FIG. 5C. Other structures are the same as those of EXAMPLE 1. The number of the frequency switching devices 6 to be provided may be set as any number of 2 or larger, as long as it is the number that can correspond to the multibands.

EXAMPLE 5 is structured to have two frequency switching devices 6, 6 provided to the slot 1. Therefore, through individually controlling ON/OFF of each of the frequency switching devices 6, 6, the electric length of the slot 1 can be changed. This makes it possible to have resonance at frequencies corresponding to a quarter wavelength of the respective slot electric lengths. Thus, it is possible to achieve the antenna which corresponds to more frequency bands than the case of EXAMPLE 1 through adjusting the positions of the frequency switching devices 6 in accordance with the frequency band to be used.

Next, specific structures of the frequency switching device used in EXAMPLES 1-5 will be described by referring to the drawings.

### Example 6

As shown in FIG. 6A and FIG. 6B, the frequency switching device 6 according to EXAMPLE 6 is configured with: a diode 8 and a capacitor 9 disposed in series across a short-side direction (X-X′ direction) of the slot 1; a power supply 10 and a bias control line 11 for applying a direct-current bias to the diode 8; and an inductor 12 disposed on the bias control line 11 to prevent inflow of a high-frequency current towards the power supply 10 side from the antenna element 2.

The power supply 10 is for applying the direct-current bias to both ends of the diode 8, i.e., for applying a forward bias (or inverse bias) to both ends of the diode 8. A switch 13 is used to apply the bias to the diode 8 when a contact turns ON, and to cut the bias when the contact turns OFF. The capacitor 9 prevents inflow of the direct-current bias into the antenna element 2.

The series circuit of the diode 8 and the capacitor 9 is disposed across the short-side direction of the slot 1 in the vicinity of the short-circuit end 1b of the slot 1.

The anode electrode side of the diode 8 is connected to one end of the capacitor 9, and the other end of the capacitor 9a and the cathode electrode side of the diode 8 are connected to the antenna element 2 across the short-side direction of the slot 1. One end terminal of the power supply 10 for applying the bias to the diode 8 is connected to the anode electrode side of the diode 8 via the switch 13 and the inductor 12, and the other end terminal thereof is connected to the cathode side of the diode 8 via the reflector 3 and the short-circuiting device 5.

The inductor 12 is disposed at least just near the anode electrode of the diode 8. The inductor 12 prevents inflow of the high-frequency current into the bias control line 11 from the antenna element 2 via the capacitor 9. There may be a single inductor 12 or a plurality of inductors 12 provided therein. It is assumed that the inductor 12 has such an electric characteristic that the impedance becomes high (e.g., −20 dB or less with an insertion loss) at the used frequency by the single inductor or a combination of inductors of a plurality of characteristics. Further, as the layout of the bias control line 11 for connecting the power supply 10 and the diode 8, it is preferable to be arranged not to go across the slot 1 and become away from the antenna element 2 with the shortest distance.

FIG. 7A and FIG. 7B show a case in which the bias system and the inductor of FIG. 6A and FIG. 6B are modified. That is, as shown in FIG. 7A and FIG. 7B, the forward bias and the inverse bias are selectively applied through switching power supplys 10A and 10b with the switch 13.

Inductors 12a and 12b are at least disposed at two points, i.e., just near the anode electrode of the diode 8 and a position outside the antenna element 2. The inductor 12a works to prevent the high-frequency current from flowing into the bias control line 11 from the antenna element 2 via the capacitor 9, and the inductor 12b works to prevent the high-frequency current from flowing into the bias control line 11 by spatial coupling between the antenna element 2 and the bias control line 11.

Each of the inductors 12a and 12b may be configured with a single inductor element or may be with a combination of a plurality of inductor elements. The inductor elements configuring the inductors 12a and 12b have such an electric characteristic that the impedance becomes high (e.g., −20 dB or less with an insertion loss) at the used frequency by the single inductor element or a combination of inductor elements of a plurality of characteristics. For the inductors 12a and 12b, those with the same electric characteristic are used. Regarding the layout interval between the inductors 12a and 12b, it is desirable to be sufficiently shorter (e.g., one tenth or shorter) with respect to the wavelength corresponding to the used frequency.

As the layout of the bias control line 11 for connecting the power supplys 10a, 10b and the diode 8, it is preferable to be arranged not to go across the slot 1 and to be out from the antenna element 2 with the shortest distance. The diode 8 may be mounted to face an inverse direction from the case of FIG. 6. In that case, however, the logic of the switch 13 which controls open/short-circuit of the diode 8 becomes inverted.

When the bias applied to the diode 8 is zero or the inverse bias (the cathode side of the diode 8 is +voltage) in EXAMPLE 6 and EXAMPLE 7, the diode 8 equivalently becomes a capacitor of several pF and comes into an open state. Therefore, the slot 1 resonates at a frequency having the electric length of the slot 1 as a quarter wavelength, and functions as an antenna.

When the forward bias (the anode side of the diode 8 is +voltage) is applied to the diode 8, the diode 8 equivalently becomes resistance of about several ohms and comes in a short-circuit state. Therefore, the slot 1 resonates an a frequency having the electric length via the frequency switching device 6 from the opening end 1a of the slot 1a as a quarter wavelength, and functions as an antenna.

As described above, the resonance frequency of the slot can be switched by controlling the bias applied to the diode 8.

### Example 8

EXAMPLE 8 shown in FIG. 8A and FIG. 8B is a modification of EXAMPLE 7 shown in FIG. 7A and FIG. 7B. That is, in EXAMPLE 8 shown in FIG. 8A and FIG. 8B, the diode 8 and the capacitor 9 which configure the series circuit of EXAMPLE 7 are replaced with two serially connected diodes 8a and 8b.

When the inverse bias is applied to the diode, the diode can be considered as a capacitor equivalently. As the used frequency of the antenna becomes higher, isolation of the diode becomes deteriorated and the antenna current is increased. Therefore, switching of the resonance frequency of the antenna becomes harder gradually.

With EXAMPLE 8, isolation can be improved by employing the structure in which the two diodes 8a and 8b are disposed in series with a common anode electrode. While FIG. 8 shows a case where the anode electrode of the diodes 8a and 8b is used in common, it is also possible to employ a structure in which the cathode electrode thereof is used in common. Further, in general, when the power applied to the diode becomes more than a certain level, an unnecessary radiation is generated due to a non-linear characteristic of the diode. When the output power of the wireless circuit is large, the power applied to the diode becomes large as well. Thus, the unnecessary radiation becomes an issue. However, with the structure of EXAMPLE 8, the power applied to each diode can be decreased, thereby making it possible to decrease the unnecessary radiation from the diodes.

### Example 9

While the frequency switching devices 6 described above are built as the structure configured by using the diodes 8, 8a, and 8b, the structure thereof is not limited only to such case. For example, it is possible to employ a structure using an field-effect transistor (FET) 14 as shown in FIG. 9A and FIG. 9B in place of the diode 8. Furthermore, it is possible to employ a structure using a small mechanical switch 15 that is built by a micromachining technique as shown in FIG. 10A and FIG. 10B. Particularly, the small mechanical switch is a mechanism component, and the linearity of the input/output characteristic is good. Thus, unnecessary radiation is not generated, even when a large power is applied. Therefore, even when the output power of the wireless circuit is large, the unnecessary radiation can be suppressed with the structure in which the small mechanical switch is used for the frequency switching device.

Next, specific mounting examples of the frequency switching device will be described.

### Example 10

A mounting example shown in FIG. 11a and FIG. 11B is a case where the frequency switching device 6 shown in FIG. 7A and FIG. 7B is mounted to the antenna element 2 by using a printed circuit board 16.

That is, as shown in FIG. 11A and FIG. 11B, the diode 8, the capacitor 9, and the inductor 12a of the frequency switching device 6 shown in FIG. 7A and FIG. 7B are mounted onto the printed circuit board 16, and the printed circuit board 16 is mounted onto the antenna element 2 by using a solder 17 or the like. Further, the inductor 12b is mounted to an area other than the antenna element 2, and the inductor 12a and the inductor 12b are connected via the bias control line 11 with the shortest distance.

### Example 11

A mounting example shown in FIG. 12A and FIG. 12B is a case where the frequency switching device 6 shown in FIG. 7A and FIG. 7B is directly loaded on the antenna element 2. Other than that, it is the same as the case shown in FIG. 11.

### Example 12

Next, described is a specific example in which a slot antenna is built by combining the reflector 3 and the antenna element 2 to which the frequency switching device 6 shown in FIG. 11A and FIG. 11B is mounted.

In FIG. 13, the antenna element 2 and the reflector 3 are combined in an opposing manner by having the frequency switching device 6 and the slot 1 facing towards the reflector 3 side. The bias control line 11 on the antenna element 2 side is connected to the bias control line 11 on the reflector 3 side from the terminal of the inductor 12b via a connection pin 18, and this bias control line 11 is connected to a bias control power supply (not shown). This bias control power supply corresponds to the power supplies 10, 10a, and 10b.

In FIG. 14, the antenna element 2 and the reflector 3 are combined in an opposing manner by having the surface of the antenna element 2 on which the slot 1 and the frequency switching device 6 are disposed in the structure of FIG. 13 facing towards the outer side (opposite side of the reflector 3). The bias control line 11 on the antenna element 2 side is connected to the bias control line 11 on the reflector 3 via the connection pin 18 and a through-hole 19 formed through the antenna element 2. Other than that, it is the same as the structure shown in FIG. 13.

In FIG. 15, as the antenna element 2, the frequency switching device 6 is mounted to the surface on the opposite side from the slot 1. Further, the antenna element 2 and the reflector 3 are combined by having the frequency switching device 6 facing towards the reflector 3 side. In this case, the frequency switching device 6 is connected to the antenna element 2 via a through-hole 20.

In the explanations above, the shape of the slot 1 provided on the antenna element 2 is described as an L-letter shape. However, the shape is not limited only to that shape. For example, through selecting the shape of the slot 1 appropriately from shapes such as a straight type, a meander type, a U-letter shape, and a Bow-Tie type, it is possible to have resonance, antenna actions, and sensitivities for polarized waves in the horizontal or perpendicular direction at low frequencies while reducing the area occupied by the slot. Further, while the number of slots 1 has been described as one or two by referring to the case where there is one slot and the case where there are two slots, it is possible to employ a structure having a multiple resonance characteristic by providing more slots. Furthermore, there has been described above assuming that there is one feeding device 4. However, a plurality of feeding devices 4 may be loaded as well. For example, when there are two or more slots 1 disposed on the antenna element 2, the feeding device 4 may be provided to each of the slots 1.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2007-130857 filed on May 16, 2007, and the disclosure thereof is hereby incorporated by reference in its entirety.

### INDUSTRIAL APPLICABILITY

As described above, the present invention provides the structure in which the frequency switching device is disposed on the slot. Therefore, the resonance frequency of the slot can be switched by performing electrical controls with the outside power supply or the like, which enables the antenna to correspond to multibands.

The number of slots to be disposed to the antenna element can be suppressed to the minimum by the use of the frequency switching device. Therefore, the area occupied by the slot antenna can be narrowed, so that the area for mounting the components can be expanded.

### BRIEF DESCRIPTION OF THE DRAWINGS

FIG. 1A is a perspective view showing a slot antenna according to EXAMPLE 1 of the present invention, FIG. 1B is a plan view showing the slot antenna according to EXAMPLE 1 of the present invention, and FIG. 1C is a sectional view showing the slot antenna according to EXAMPLE 1 of the present invention;

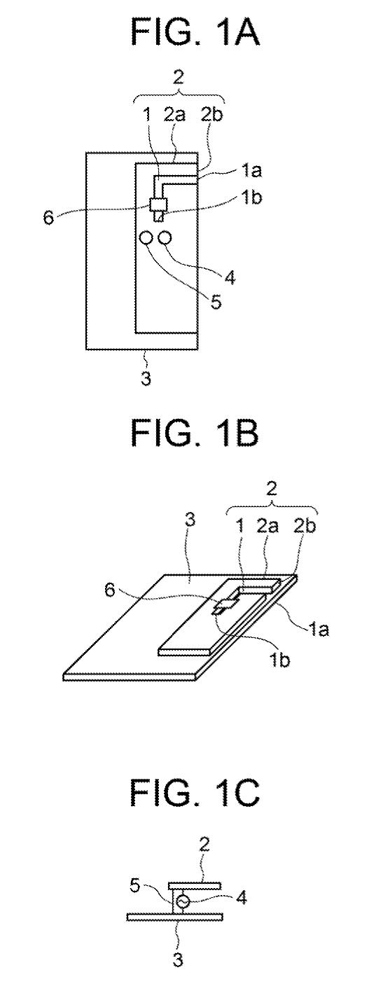

FIG. 2A is a perspective view showing a slot antenna according to EXAMPLE 2 of the present invention, FIG. 2B is a plan view showing the slot antenna according to EXAMPLE 2 of the present invention, and FIG. 2C is a sectional view showing the slot antenna according to EXAMPLE 2 of the present invention;

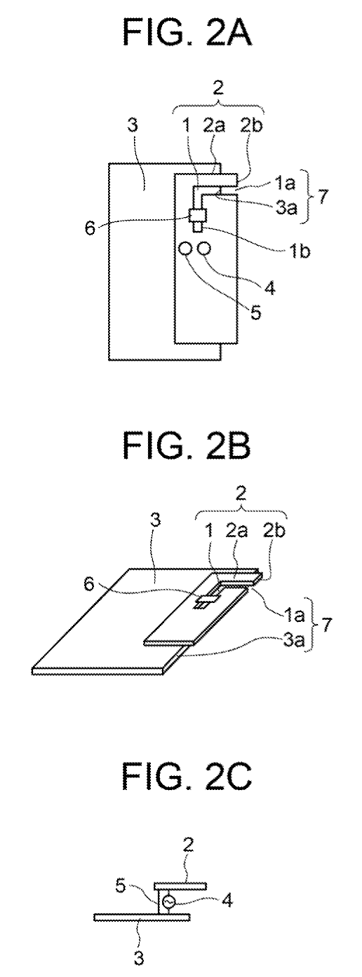

FIG. 3A is a perspective view showing a slot antenna according to EXAMPLE 3 of the present invention, FIG. 3B is a plan view showing the slot antenna according to EXAMPLE 3 of the present invention, and FIG. 3C is a sectional view showing the slot antenna according to EXAMPLE 3 of the present invention;

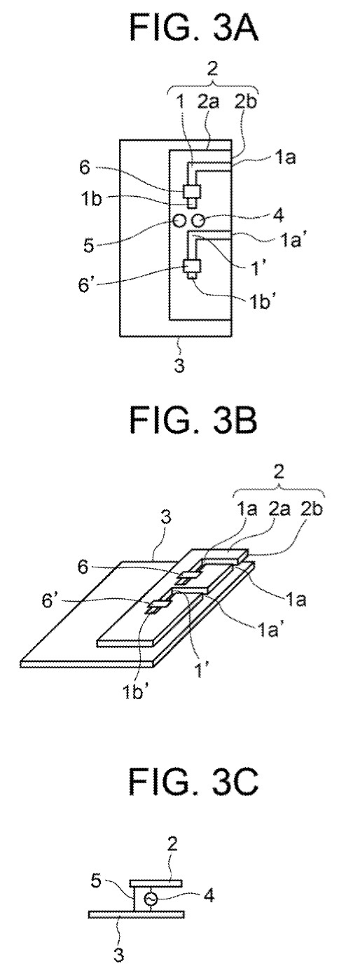

FIG. 4A is a perspective view showing a slot antenna according to EXAMPLE 4 of the present invention, FIG. 4B is a plan view showing the slot antenna according to EXAMPLE 4 of the present invention, and FIG. 4C is a sectional view showing the slot antenna according to EXAMPLE 4 of the present invention;

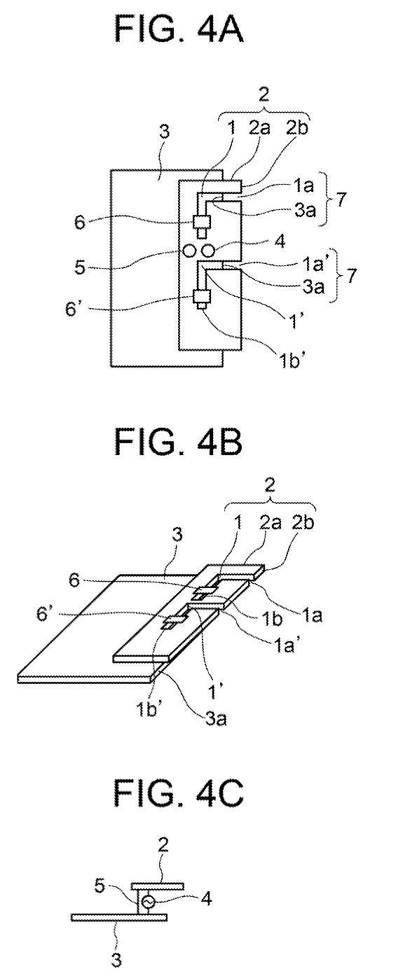

FIG. 5A is a perspective view showing a slot antenna according to EXAMPLE 5 of the present invention, FIG. 5B is a plan view showing the slot antenna according to EXAMPLE 5 of the present invention, and FIG. 5C is a sectional view showing the slot antenna according to EXAMPLE 5 of the present invention;

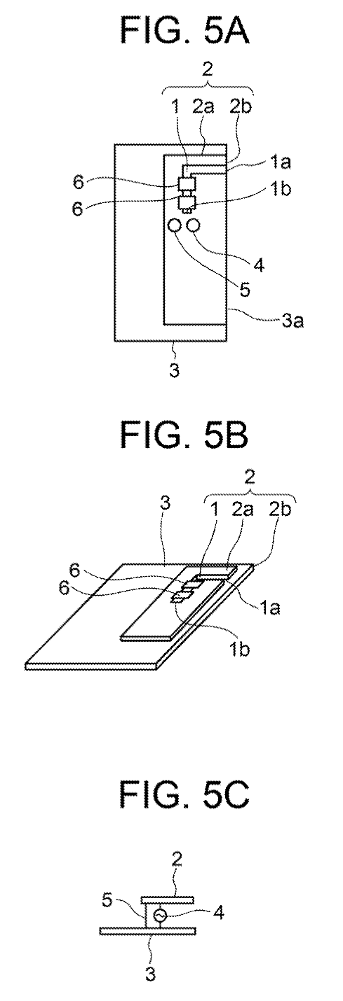

FIG. 6A is a plan view showing a specific example of a frequency switching device used in EXAMPLES of the present invention, and FIG. 6B is a sectional view showing a specific example of the frequency switching device used in EXAMPLES of the present invention;

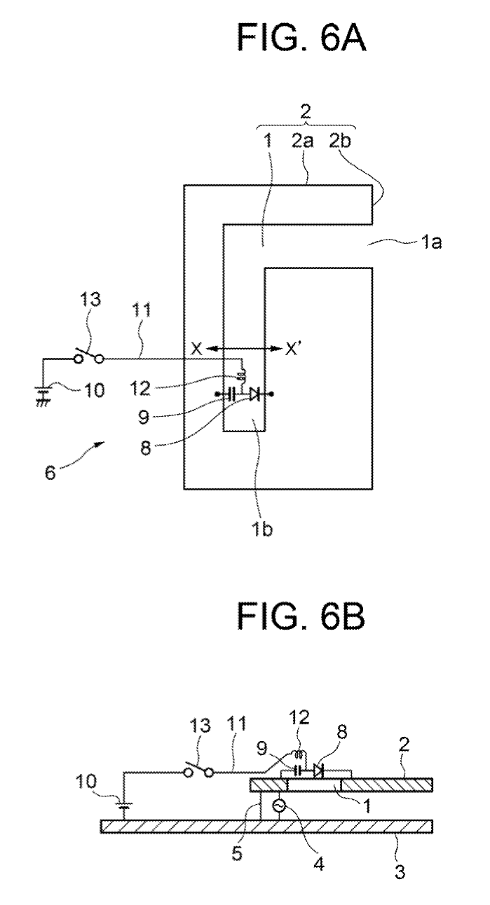

FIG. 7A is a plan view showing a specific example of the frequency switching device used in EXAMPLES of the present invention, and FIG. 7B is a sectional view showing a specific example of the frequency switching device used in EXAMPLES of the present invention;

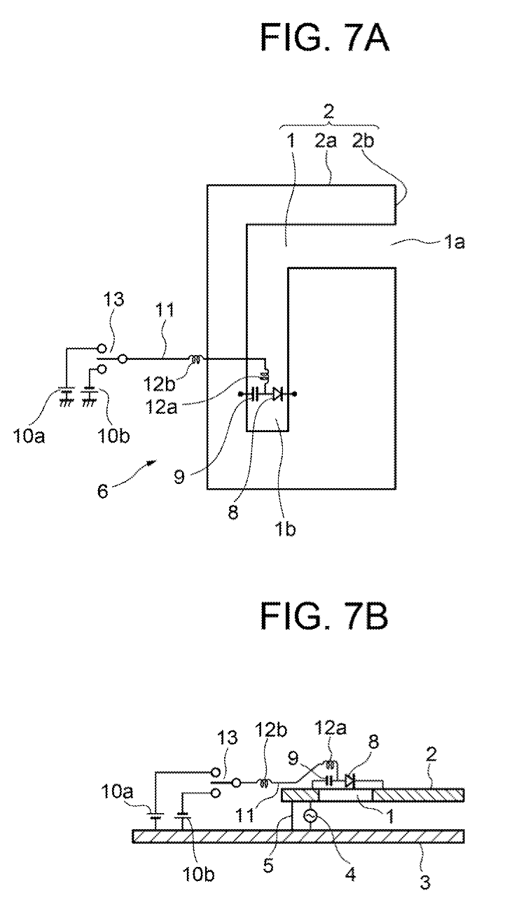

FIG. 8A is a plan view showing a specific example of the frequency switching device used in EXAMPLES of the present invention, and FIG. 8B is a sectional view showing a specific example of the frequency switching device used in EXAMPLES of the present invention;

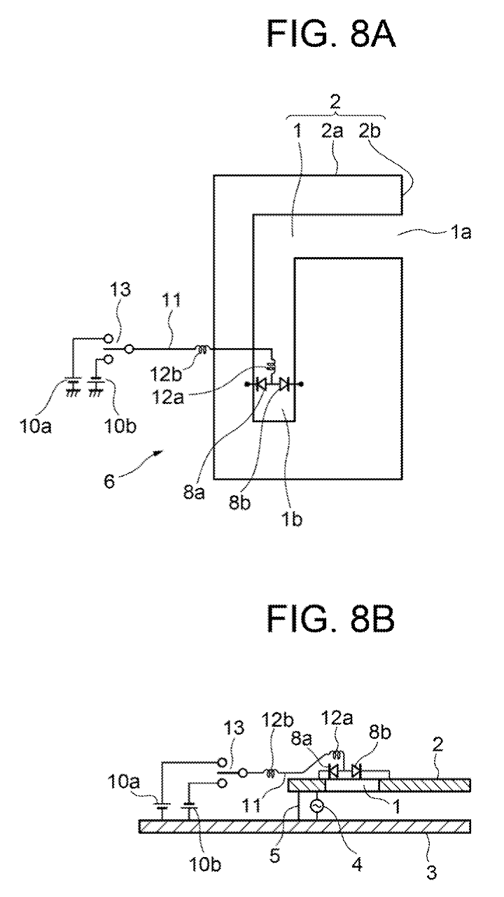

FIG. 9A is a plan view showing a specific example of the frequency switching device used in EXAMPLES of the present invention, and FIG. 9B is a sectional view showing a specific example of the frequency switching device used in EXAMPLES of the present invention;

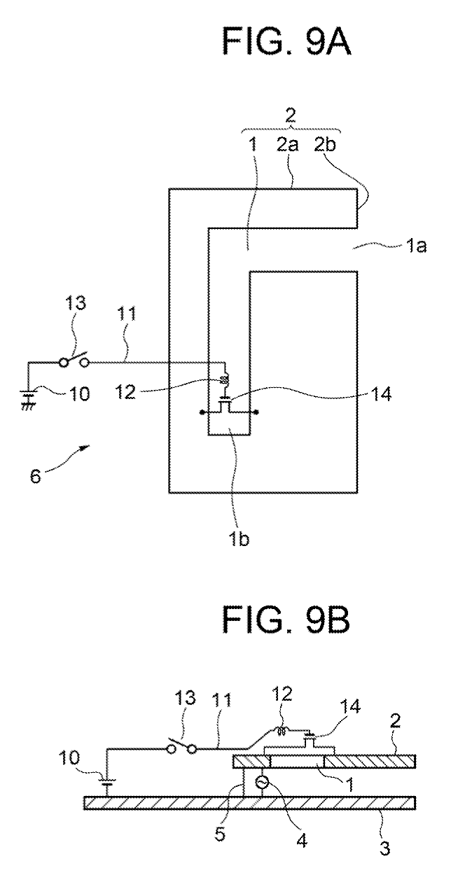

FIG. 10A is a plan view showing a specific example of the frequency switching device used in EXAMPLES of the present invention, and FIG. 10B is a sectional view showing a specific example of the frequency switching device used in EXAMPLES of the present invention;

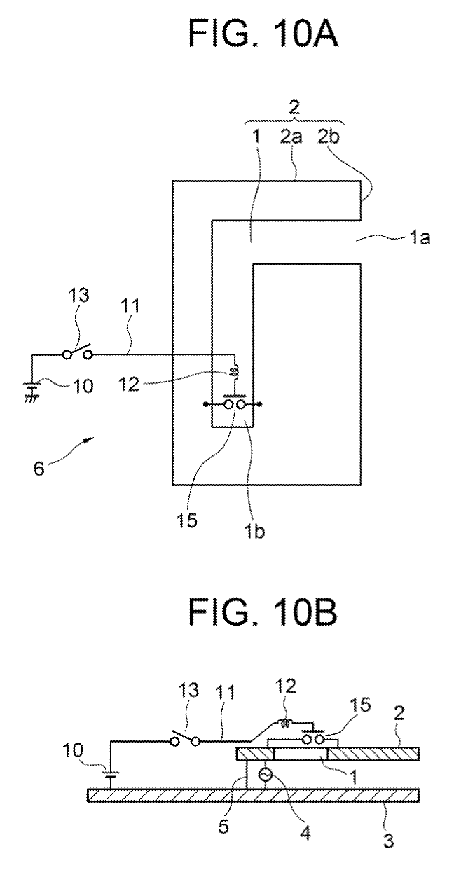

FIG. 11A is a plan view showing a state where the frequency switching device used in EXAMPLES of the present invention is mounted to an antenna element, and FIG. 11B is a sectional view showing the state where the frequency switching device used in EXAMPLES of the present invention is mounted to an antenna element;

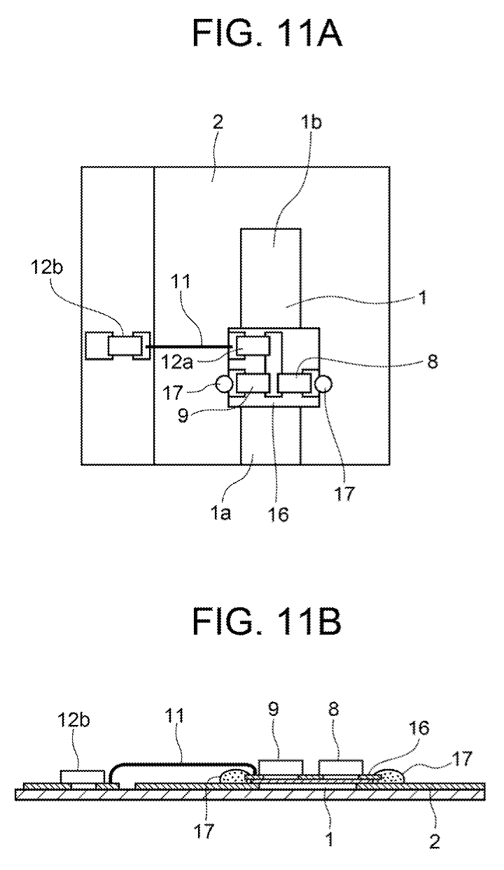

FIG. 12A is a plan view showing a state where the frequency switching device used in EXAMPLES of the present invention is mounted to an antenna element, and FIG. 12B is a sectional view showing the state where the frequency switching device used in EXAMPLES of the present invention is mounted to an antenna element;

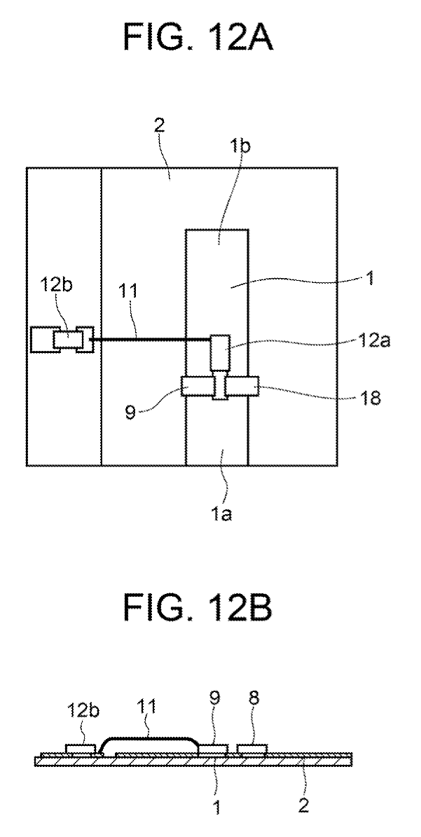

FIG. 13 is a sectional view showing a state where a slot antenna is built by combining a reflector and the antenna element to which the frequency switching device used in EXAMPLES of the present invention is mounted;

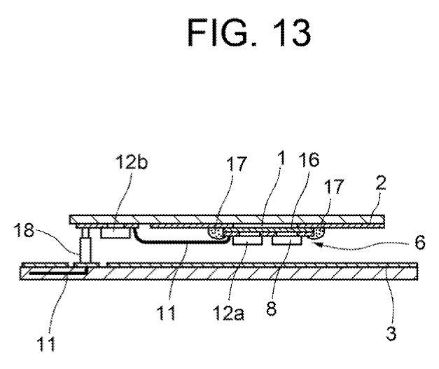

FIG. 14 is a sectional view showing a state where a slot antenna is built by combining a reflector and the antenna element to which the frequency switching device used in EXAMPLES of the present invention is mounted;

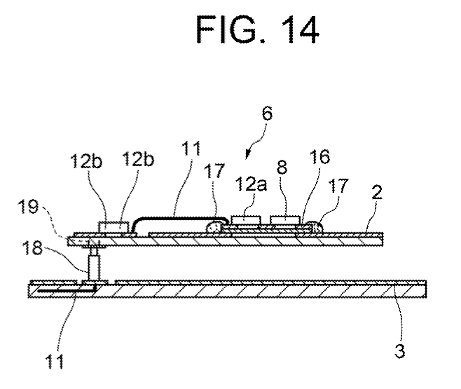

FIG. 15 is a sectional view showing a state where a slot antenna is built by combining a reflector and the antenna element to which the frequency switching device used in EXAMPLES of the present invention is mounted;

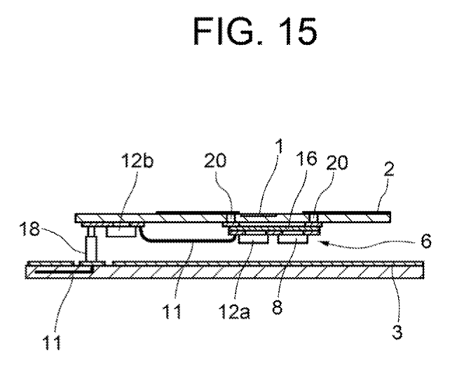

FIG. 16 A is a detailed perspective view showing an antenna according to a related technique, and FIG. 16B is a sectional view thereof; and

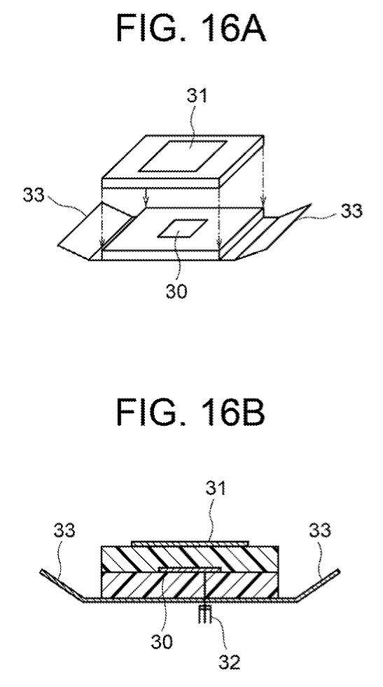

FIG. 17 is a sectional view showing an antenna according to a related technique.

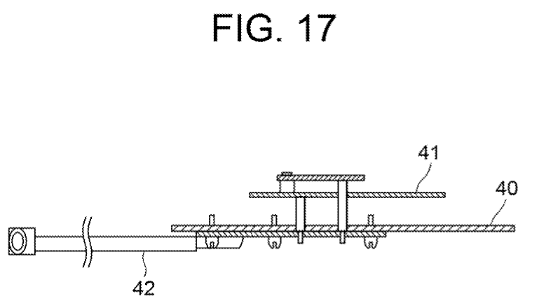

### REFERENCE NUMERALS

1 Slot
2 Antenna element
3 Reflector
4 Feeding device
5 Short-circuiting device
6 Frequency switching device
7 Adjuster

What is claimed is:

1. A slot antenna, comprising:
an antenna element having an aperture slit shaped slot;
a reflector disposed by being opposed to the antenna element;
a feeding device which is electrically and physically connected to the antenna element and the reflector;
a short-circuiting device which electrically short-circuits the antenna element and the reflector; and
a frequency switching device which switches resonance frequencies of the slot.

2. The slot antenna as claimed in claim 1, wherein the short-circuiting device is disposed near the slot.

3. The slot antenna as claimed in claim 1, wherein the frequency switching device is configured with a diode disposed across the slot, a power supply which sends out a direct-current bias, and a bias control line which connects the diode to the power supply so as to switch the resonance frequencies of the slot by applying the direct-current bias to the diode via the bias control line.

4. The slot antenna as claimed in claim 1, wherein the frequency switching device includes the diode, the bias control line, a capacitor which prevents the direct-current bias from flowing into the antenna element side, and an inductor which prevents a high-frequency current from flowing out from the antenna element side.

5. The slot antenna as claimed in claim 4, wherein the frequency switching device is formed by replacing the capacitor with a diode so as to prevent the direct-current bias from flowing into the antenna element side with a combination of the diodes.

6. The slot antenna as claimed in claim 3, wherein the frequency switching device performs controls with two kinds of direct-current biases, i.e., a forward bias and an inverse bias applied to the diode.

7. The slot antenna as claimed in claim 5, wherein the inductor is disposed at least just near the diode and outside the antenna element.

8. The slot antenna as claimed in claim 3, wherein the frequency switching device is configured with an FET (field-effect transistor) disposed across the slot, a power supply which sends out a direct-current bias, and a bias control line which connects the diode to the power supply so as to switch the resonance frequencies of the slot by applying the direct-current bias to the FET via the bias control line.

9. The slot antenna as claimed in claim 1, wherein the frequency switching device is disposed near a short-circuit end that is on the opposite side of an opening end of the slot.

10. The slot antenna as claimed in claim 1, comprising an adjuster for reducing a reactance component of the antenna.

11. The slot antenna as claimed in claim 3, wherein the frequency switching device is configured with a small mechanical switch disposed across the slot, a power supply which sends out a direct-current bias, and a bias control line which connects the diode to the power supply so as to switch the resonance frequencies of the slot by applying the direct-current bias to the small mechanical switch via the bias control line.

12. A slot antenna, comprising:
an antenna element having an aperture slit shaped slot;
a reflector disposed by being opposed to the antenna element;
a feeding device which is electrically and physically connected to the antenna element and the reflector;
short-circuiting means for electrically short-circuiting the antenna element and the reflector; and
frequency switching means for switching resonance frequencies of the slot.
